(19) United States
(12) Patent Application Publication
(10) Pub. No.: US 2004/0186600 A1
(43) Pub. Date: Sep. 23, 2004

(54) Electronic video poker and card keno (pack) machine

(76) Inventors: John Tumacder, Reno, NV (US); Delmalyn U. Tumacder, Reno, NV (US)

Correspondence Address: John Tumacder, #267, 4790 Caughlin Pkwy, Reno, NV, 89509, US

(21) Appl. No.: 10/800,804

(22) Filed: Mar. 15, 2004

Related U.S. Application Data
(60) Provisional application No. 60/456,623, filed on Mar. 21, 2003.

(51) Int. Cl. G06F 17/00

(52) U.S. Cl. 700/91

(57) ABSTRACT

Before a player is dealt the five cards in the video poker game, the player makes a separate bet on predicting what cards will be dealt on the initial five card deal. In a preferred embodiment the upper half of the game display depicts the entire deck of cards used in the particular video poker game. The player marks up to five cards on the display of cards, and if the player has accurately predicted any of the five cards that were subsequently dealt at the commencement of the video poker game, the player is then awarded credits based on the amount wagered, number of cards selected, and number of selected cards which were actually dealt. The player may also make a similar bet on predicting what cards will be dealt in the draw portion of the video poker game and again be awarded credits based on the amount wagered, number of cards selected, and number of selected cards which were actually dealt in the draw.

### CROSS-REFERENCE TO RELATED APPLICATIONS

This Application claims the benefit of Applicants' provisional patent Application No. 60/456,623 entitled Electronic video poker and card keno (PACK) machine, filed Mar. 21, 2003.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates primarily to any variation of draw poker machines involving the playing of only one hand. Since the advent of the basic draw poker machines they have become very popular among gaming machine players. This invention secondarily relates to electronic video keno, a game where a player is awarded credits for accurately marking on a field of numbers 1 to 80 inclusive which numbers will be randomly lit up during the game. In electronic video keno twenty of the eighty numbers are usually lit up and a player can select from one to ten numbers in most versions of video keno. The player is awarded pre-established credits based on the amount of the wager, the amount of numbers selected, and the actual amount of marked numbers which were lit up. Substantial jackpots are awarded if a player marked ten numbers and all ten numbers were lit up. Video keno is also very popular among gaming machine players.

Most casinos will have a number of poker machines as well as a number of video keno machines. Players who enjoy playing both games may only play one or the other at a time. This invention unites draw poker with an aspect of video keno. Hence the name given to this invention is Poker And Card Keno (PACK) machine. Instead of predicting which numbers will come up on a field of numbers as is done in video keno, the PACK machine player is given the chance to predict which cards will be dealt in the poker game. This opportunity to bet on which cards will be dealt is provided the player at the initial deal of five cards as well as on the deal of replacement cards in the draw portion of the poker game.

From the point of view of both players and casino operators, novelty and excitement are of paramount importance. Players seek to play gaming machines that are interesting and which can offer the chance of a big jackpot. Casino operators want to provide their customers with new and exciting gaming machines to replace older machines that have lost their appeal to players. A gaming machine concept which could offer a huge jackpot for a small wager would have appeal to both players and casino operators. This invention is designed to satisfy the desires of both players and casino operators.

### BRIEF SUMMARY OF THE INVENTION

An object of the present invention is to combine the excitement of playing video poker and playing a keno type game at the same time.

A jackpot bonus similar in magnitude to winners of state run lotteries may be awarded in the card keno aspect of this invention. Multimillion dollar jackpots are commonly won by lottery ticket holders who have accurately predicted five or six numbers which were drawn from a field of numbers usually between 1 to 48 or thereabouts inclusive. The odds of getting five out of five are astronomically low. The odds of a player accurately predicting the five cards dealt on the initial deal in the card keno game is similar to state run lottery odds. Therefore a huge jackpot may be awarded to the player who eventually does pick five out of five cards.

This invention thus combines the excitement of playing for a royal flush jackpot in the poker game and the excitement of a chance to win a lottery sized jackpot in the card keno aspect of the invention for a small wager at the same time.

This invention solves the problem of casino operators to provide a new and exciting way to combine two well established games, video poker and video keno.

This invention satisfies the desires of players who enjoy both video poker and video keno and gives them a chance to play both at the same time.

This invention appeals to lottery ticket buyers who purchase a lottery ticket for a small amount in the hopes of winning a life changing jackpot and gives them the opportunity for instant feedback by taking their chances on this present invention.

### BRIEF DESCRIPTION OF THE SEVERAL VIEWS OF THE DRAWING

FIG. 1 shows the screen at the beginning of the game

FIG. 2 shows the screen after the player has marked one card

FIG. 3 shows the screen after the player has marked a second card

FIG. 4 shows the screen after the player has marked a third card

FIG. 5 shows the screen after the player has marked a fourth card

FIG. 6 shows the screen after the player has marked a fifth card

FIG. 7 shows the screen after the initial deal of five cards

FIG. 8 shows the screen after the player has held two cards and marked three cards.

FIG. 9 shows the screen after the draw for the replacement cards

### DETAILED DESCRIPTION OF THE INVENTION

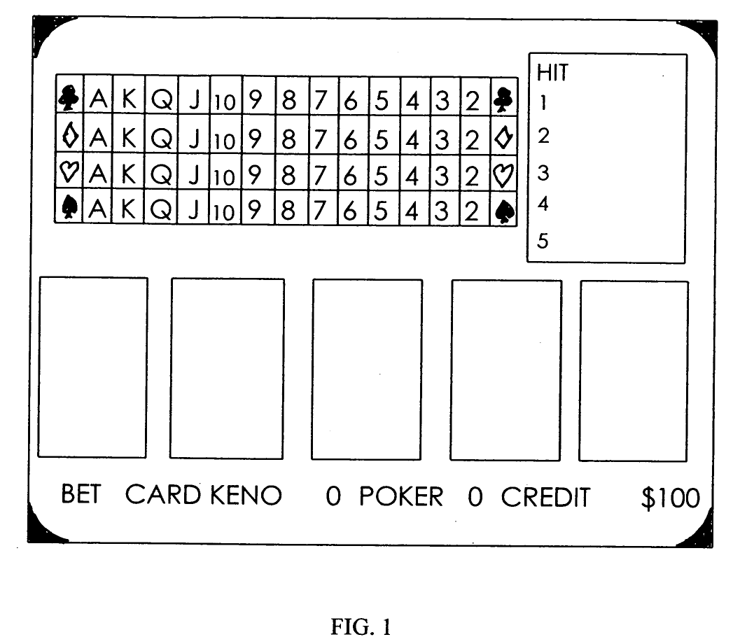

The present invention includes a variety of electronic video poker games involving one five card hand dealt out at a time. In those games the upper half of the video screen is either blank or contains the pay table. In this present invention the upper half of the screen contains a display of the entire deck of cards used in the poker game. If no jokers are used in the particular version, the 52 cards of a standard deck of cards are displayed on the upper half of the screen on a 13 by 4 space grid. To the right of the card display field is an area wherein will be displayed the pay outs for the card keno game. FIG. 1 depicts the appearance of the Poker And Card Keno (PACK) Machine video screen.

After the player has made a separate wager on the poker game and on the card keno game, the machine issues a prompt to select up to five cards. By using conventional touch screen technology the player can mark up to five cards on the field of cards. The player may select between one to five cards.

When a card or cards are marked, the pay out for any hits, that is, the accurate marking of cards which are actually dealt out, is indicated on the right of the card display field. The pay out amounts are pre-established and are based upon the amount wagered, the number of cards selected, and the number of hits.

The first five cards are dealt and displayed on the bottom half of the screen when the player activates the start of the poker game. As each of the five cards are dealt out, the corresponding card on the card field lights up or is otherwise highlighted. If the player has accurately marked cards which were actually dealt out, then the player is awarded credits based on the displayed pay out schedule.

The player then continues with the draw poker game by selecting cards which are to be held. The player may then play card keno on the deal for the replacement cards. If the player elects to do so, then the player makes another card keno wager. The player then marks up to as many cards on the card field as are being discarded. If the player is holding two cards, then up to three cards may be marked on the card field. When marks are made the pay out schedule will display the award for hits based upon pre-established guidelines. The discards on the card field remain lit or highlighted so the player will not inadvertently pick cards that are no longer in play. The player then activates the draw for the replacement cards. As in the initial deal of five cards, if the player has accurately marked cards which were actually dealt out, then the player is awarded credits based on the pre-established pay out schedule.

The poker game concludes at this point. If the player's five card poker hand qualifies as a winner according to the particular game's pay table, then credits are added accordingly.

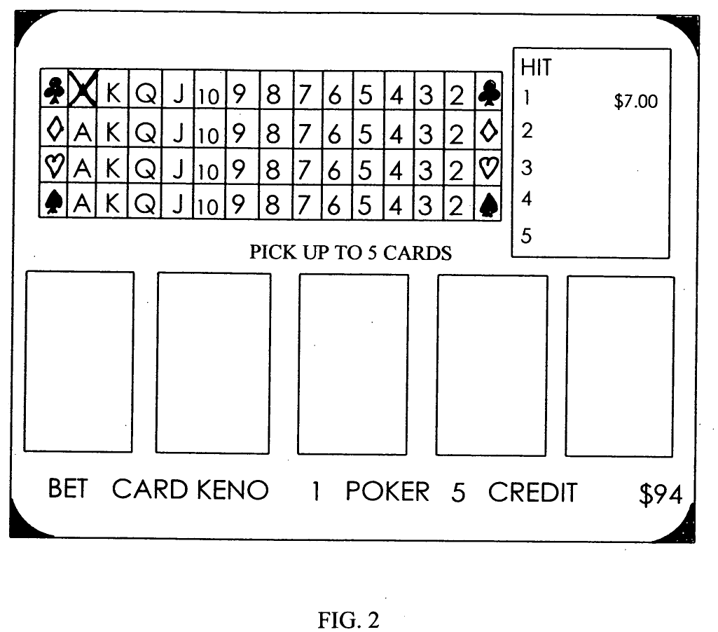

An example of the method of play of the present invention is demonstrated beginning with FIG. 2. The player has made a $5 wager on the poker game and a $1 wager on the card keno game. The player's credit meter shows a balance of $94. The prompt appears on the screen to pick up to 5 cards. The player has touched the spot designating the Ace of clubs hoping that card will come out on the initial deal. The pay out schedule indicates that if no other cards are marked and the Ace of clubs was dealt in the initial deal, the player would be awarded $7.

Note: The credits to be awarded on the card keno game may be adjusted to the specifications of the purchaser of the PACK machine. No particular percentage is used in this example of a sample game except that the sample pay outs are less than true odds. This present invention is intended to include any percentage of true odds' pay out schedule on the card keno aspect of this invention.

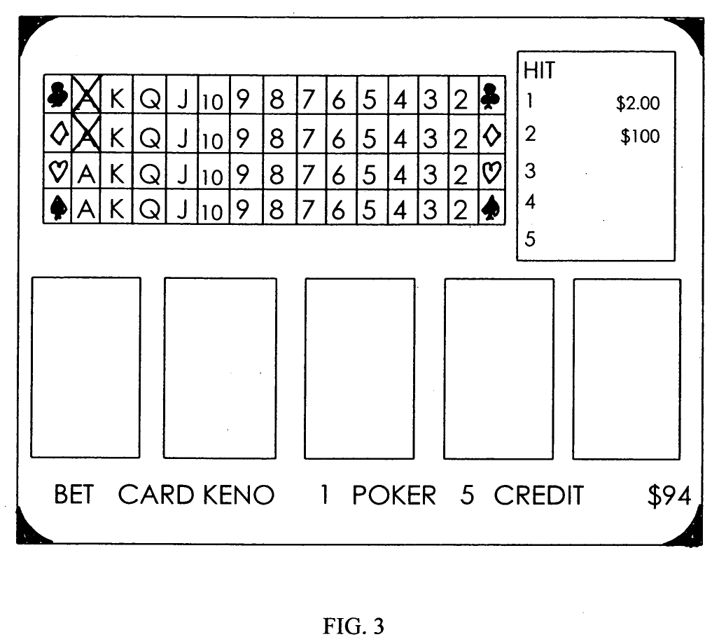

FIG. 3 shows that the player has also marked the Ace of diamonds spot. The card keno pay out table now indicates that if both cards are dealt out, the player would be awarded $100. If only one of the marked Aces were dealt, the player would receive $2.

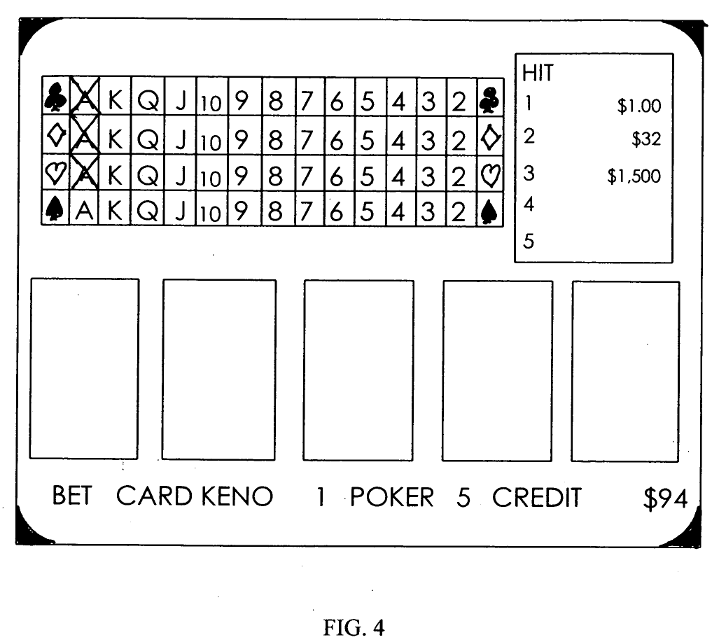

FIG. 4 shows the Ace of hearts is the third card marked. The pay out schedule now indicates $1,500 if all three marked Aces are dealt, $32 if two of the marked Aces are dealt, and $1 if only one of the marked Aces is dealt.

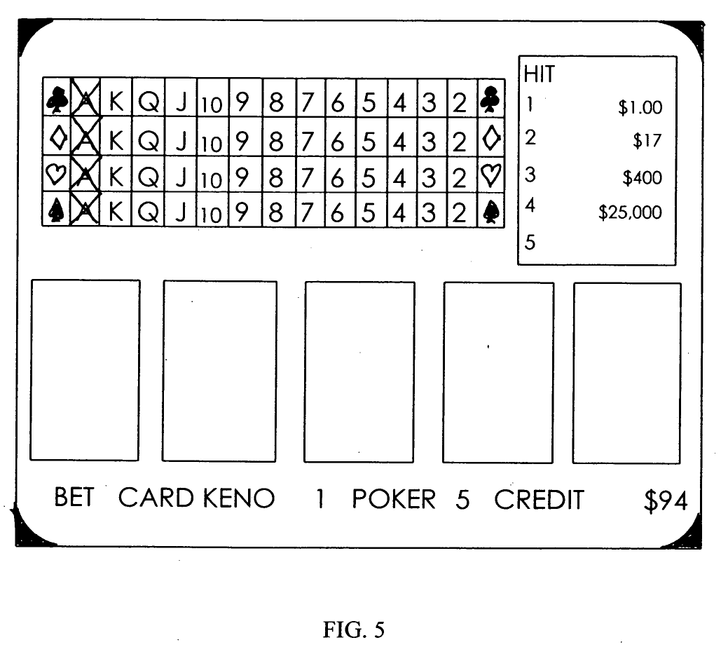

FIG. 5 shows the fourth card, the Ace of spades as marked. If no other card is marked and all four Aces were dealt on the initial deal, the player gets a jackpot of $25,000. 3 of 4 pays $400, 2 of 4 pays $17, and 1 of 4 pays $1.

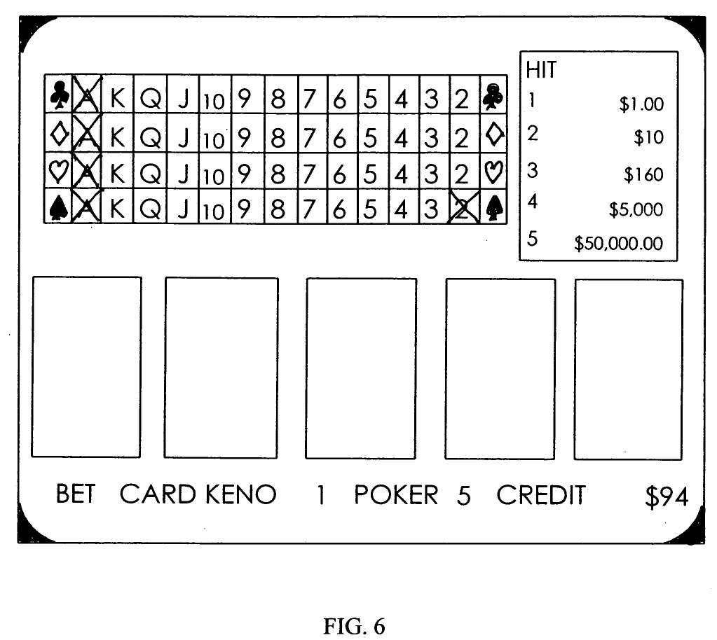

FIG. 6 shows a fifth card, the deuce of spades as marked. The pay out schedule now shows a $50,000 jackpot for hitting all 5 of 5, $5,000 for hitting 4 of 5, $160 for hitting 3 of 5, $10 for hitting 2 of 5, and $1 for hitting 1 of 5.

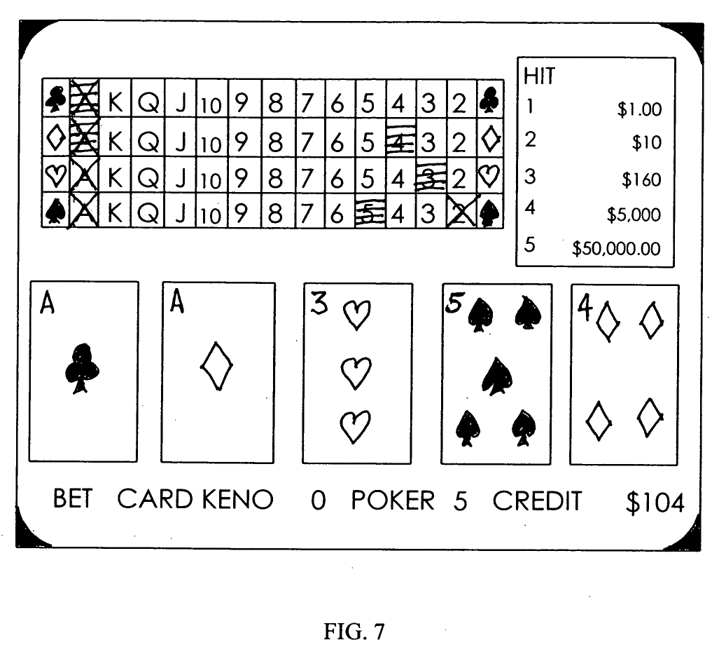

FIG. 7 shows the screen after the first five cards were dealt. The Aces of clubs and diamonds, the three of hearts, the five of spades, and the four of diamonds were dealt. Those five cards are highlighted on the card field. In the drawings horizontal lines are used. The player got two hits, the Ace of clubs and the Ace of diamonds. The player wins $10 for getting 2 hits out of 5 marks as set forth on the pay out table. The player's credit meter now shows an increase of $10 to $104.

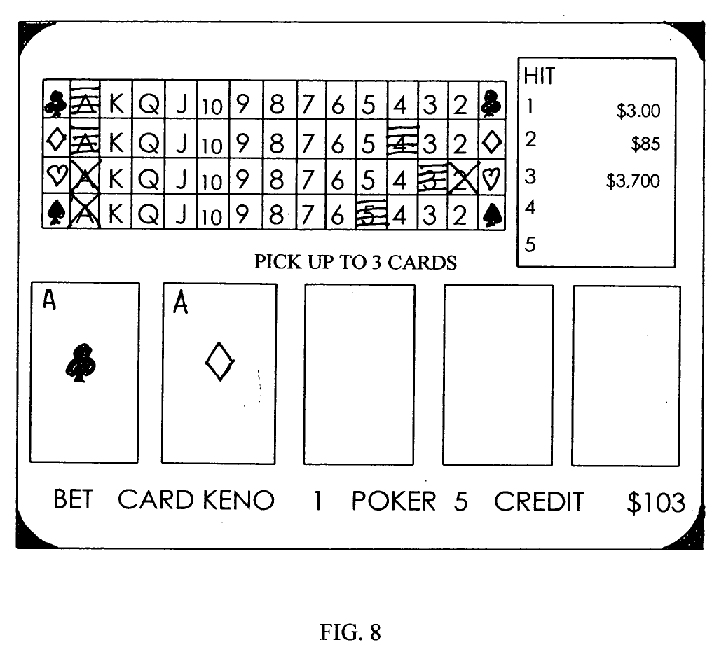

FIG. 8 shows that the player has held the Aces of clubs and diamonds in the poker game. The player has made another $1 card keno bet reducing the credit amount to $103. The prompt “pick up to 3 cards” now appears on the screen. The player has marked three cards. The player continues to mark the Aces of hearts and spades and instead of continuing to mark the deuce of spades, the player has elected to mark the deuce of hearts. The card keno pay out table now shows 3 hits out of 3 pays $3,700, 2 hits out of 3 pays $85, and 1 hit out of three pays $3.

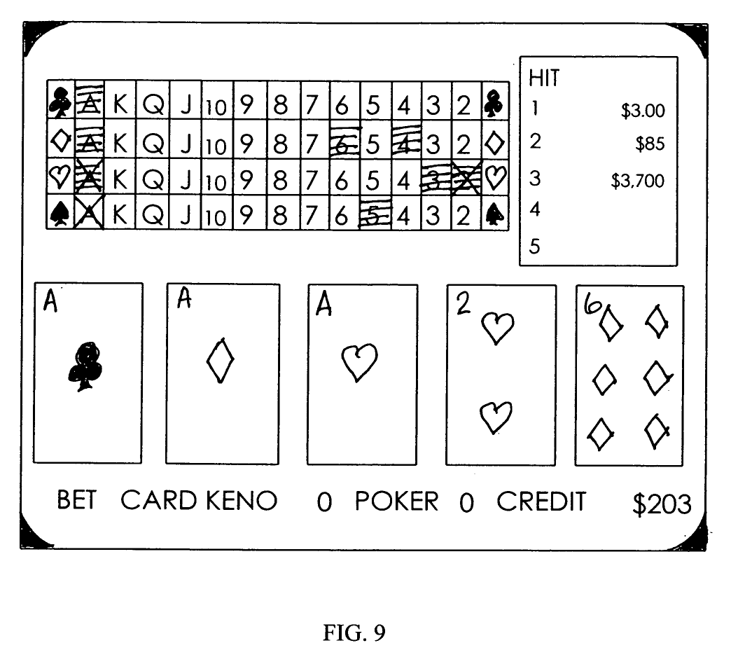

FIG. 9 shows the screen after the draw cards are dealt. The Ace of hearts, the deuce of hearts, and the six of diamonds were dealt in the draw. The player got 2 hits out of the 3 marks resulting in a win of $85. The player's poker hand also qualified as a winner for having three of a kind which in this example pays $15. The player thus has won an additional total of $100 and hence the credit meter now reads $203.

This invention includes the option of having multiple card keno cards on the upper half of the video screen. Such a feature would allow the player to play several card keno games on each deal of the cards.

We claim:

1. a method of combining the playing of a card game and the playing of a game similar to a keno game comprising:
a) a separate wager made on the poker game;
b) a separate wager made on the card keno game;
c) providing the means for the player to select and mark up to five cards from a displayed field of the entire deck of cards used in the poker game
d) dealing five cards out for the poker game
e) awarding credits on the card keno game according to a pre-established pay table based on the amount wagered, the number of cards marked, and the number of cards that were actually dealt out.

2. The method of playing a poker and card keno game according to claim 1 wherein the player may make a wager on which cards will be dealt in the draw portion of the poker game comprising:
a). the player selecting the cards to be discarded in the poker game;
b) the player making a wager on the card keno game;
c) the player selecting from the displayed field of cards the card or cards predicted to replace the discards;
d) awarding credits according to a pre-established pay table if the player has accurately predicted the card or cards dealt out to replace the discard or discards.

3. The method of playing a poker game according to claim 1 wherein said poker game is five card draw in which winnings are based on poker hand rankings and set forth in a pre-established pay table.
